(19) United States
(12) Patent Application Publication
(10) Pub. No.: US 2009/0018521 A1
(43) Pub. Date: Jan. 15, 2009

(54) SAFETY APPARATUS FOR TRANSFUSIONS OF BLOOD OR BLOOD DERIVATIVES AND METHOD FOR THE USE THEREOF

(76) Inventor: Pier Luigi Delvigo, Camogli (IT)

Correspondence Address: BROOKS KUSHMAN P.C., 1000 TOWN CENTER, TWENTY-SECOND FLOOR, SOUTHFIELD, MI, 48075, US

(21) Appl. No.: 10/595,852

(22) PCT Filed: Oct. 27, 2004
(86) PCT No.: PCT/EP04/52673

§ 371 Date: May 16, 2006

(30) Foreign Application Priority Data
Nov. 18, 2003 (IT) GE 2003A000094

(51) Int. Cl. A61J 1/18; A61J 1/10

(52) U.S. Cl. 604/404; 604/408

(57) ABSTRACT

Safety apparatus for transfusions of blood or blood derivatives contained inside at least one bag (1) having at the bottom at least one tube (2) made of elastically deformable material such as rubber or the like, for discharging the blood or blood derivatives; said blood or blood derivatives belong to a given blood group with an associated Rh factor; said apparatus comprises a constriction device (3) closed by suitable clamping means (14, 15) movable about said tube (2) so as to prevent the blood or blood derivatives which leave the bag (1) from passing through said tube (2); said constriction device (3) is provided with a seat (4) on which suitable elements (6,7) for coding and identifying said blood group with associated Rh factor are formed, which elements co-operate with a unique key (19) which establishes the identity of the blood group of the patient and, in the event of compatibility, allows opening of said constriction device (3) provided with suitable elements (5, 21, 22) complementing said coding elements (6, 7) and able to release said clamping means (14, 15) so as to open said constriction device (3) and free said tube (2).

The present invention relates to a safety apparatus for transfusions of blood or blood derivatives and to a method for use thereof.

Normally blood transfusions carried out in an operating theatre on patients who must undergo a given operation are performed by connecting to a container or bag containing blood or blood derivatives means for transfusion of the blood or blood derivatives to the patient, such as a drip associated with a venous catheter. One of the main problems which occurs most frequently when it is required to perform a transfusion is that of ensuring that the patient undergoing the transfusion receives the blood or blood derivatives which are compatible with his/her blood group. Checking of the identity of the patient's blood group and its compatibility with the blood or blood derivatives contained inside the bag is performed only visually, i.e. by checking the label of the bag and the patient's blood group recorded on a tab, with the result that errors may occur, in particular in emergency situations where a very limited amount of time is available.

The document U.S. Pat. No. 5,295,028, which belongs to the owner of the present application, describes a device for transfusions of blood or blood derivatives comprising: a container for blood or blood derivatives; a device for transfusion of the blood or blood derivatives to a patient; and a device for connecting the container to the transfusion device; this connection device comprises a coupling system formed by two central tubular elements which can be connected together and both provided with complementary coding devices, and a device for closing the elements which can be connected together.

The main drawback of this transfusion device described in the document U.S. Pat. No. 5,295,028 is that the abovementioned connection device with associated coupling system acts directly on the blood flow leaving the container; it is therefore necessary to check very carefully and on each occasion that the entire device is sterile, and in any case the degree of safety offered by the device is clearly not optimum, as it instead should be.

The main object of the present invention is therefore that of providing a safety apparatus for transfusions of blood or blood derivatives which is simple to use, low-cost, which avoids interaction with the blood contained in the associated bag and hence does not require sterilisation or scrupulous checks, allows checking as to the identity of the patient's blood group, guarantees the compatibility of the transfused blood group with Rh factor and does not interfere with the procedures adopted in the individual hospitals.

The present invention therefore relates principally to a safety device for transfusions of blood or blood derivatives contained inside at least one bag having at the bottom at least one tube made of elastically deformable material such as rubber or the like, for discharging the blood or blood derivatives; said blood or blood derivatives belong to a given blood group with associated Rh factor; characterized in that it comprises a constriction device closed by suitable clamping means movable about said tube so as to prevent the blood or blood derivatives which leave the bag from passing through said tube; said constriction device is provided with a seat on which suitable elements for coding and identifying said blood group with associated Rh factor are formed, which elements co-operate with a unique key for opening said constriction device provided with suitable elements complementing said coding elements and able to release said clamping means so as to open said constriction device and free said tube.

The present invention also relates to a method for using the present apparatus according to claim 26 and the following claims.

Further objects and advantages of the present invention will be understood more clearly during the course of the following description considered by way of a non-limiting example with reference to the accompanying drawings, in which:

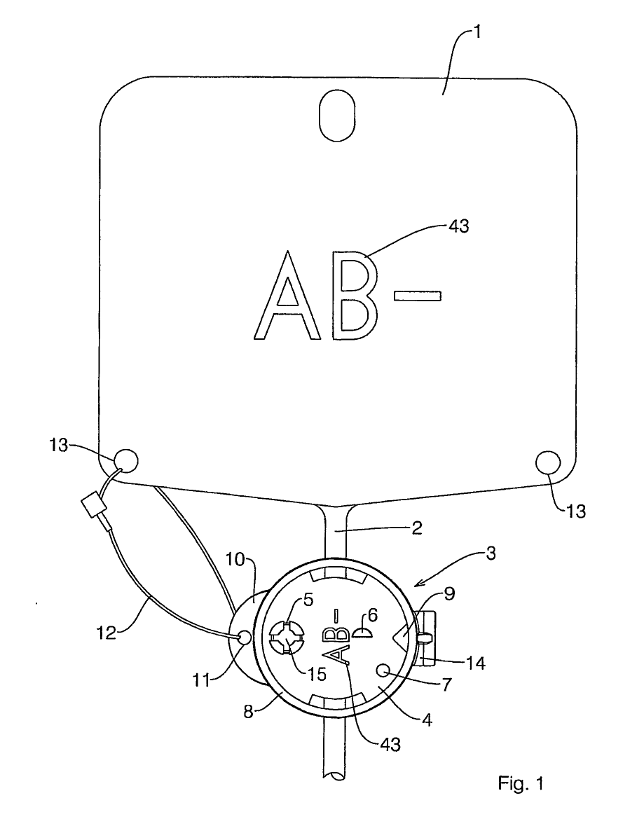

FIG. 1 shows a schematic side elevation view of a bag for blood transfusions, provided at the bottom with at least one tube for discharging the blood, on which a constriction device envisaged in a first embodiment of the safety apparatus according to the present invention is mounted;

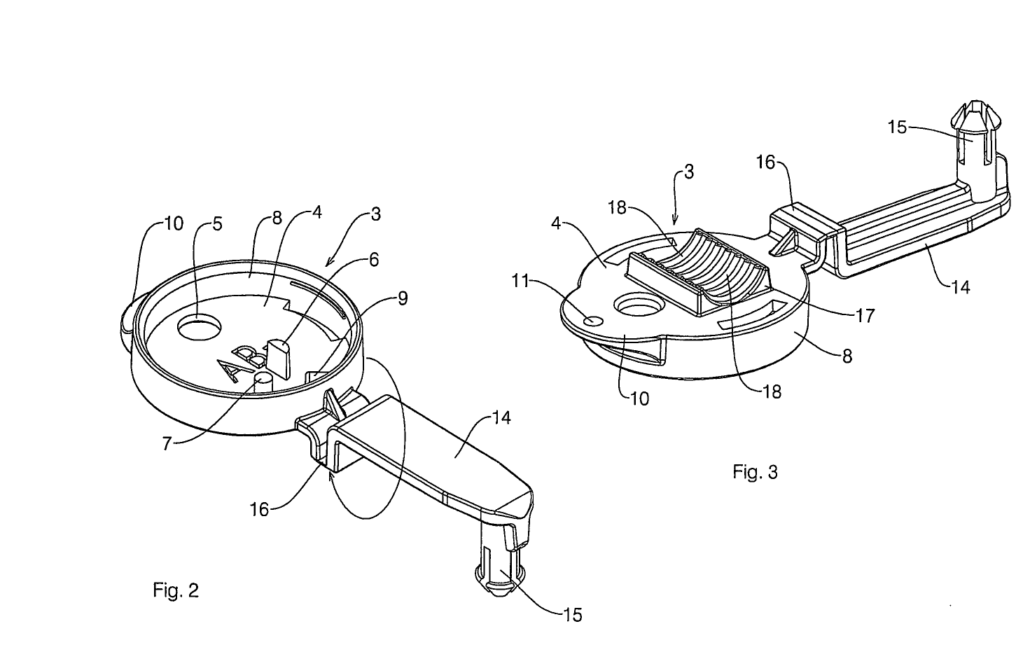

FIG. 2 shows a perspective view, from above, of the constriction device according to FIG. 1 in the open condition;

FIG. 3 shows a perspective view, from below, of the constriction device according to FIG. 1 in the open condition;

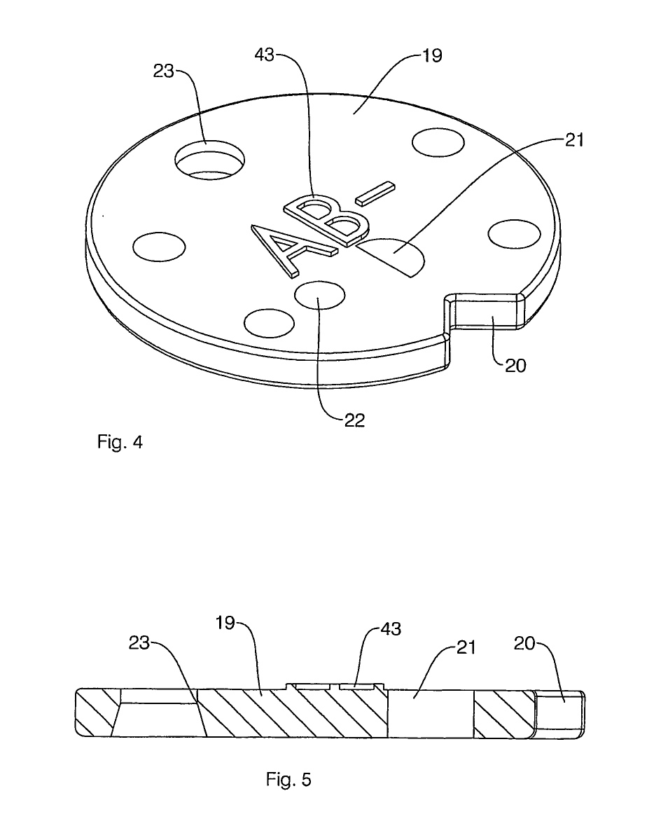

FIG. 4 shows a perspective view of a tag for checking the identity of the patient's blood group and for opening the constriction device according to FIG. 1;

FIG. 5 shows a side elevation and sectioned view of the opening tag according to FIG. 4;

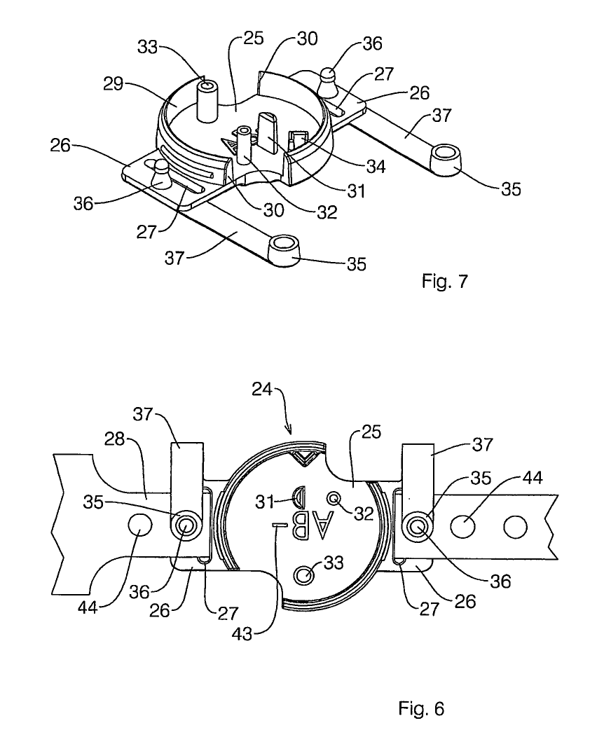

FIG. 6 shows a partial view, from above, of a wrist-band which can be fastened to a patient's wrist and has a face-plate for receiving the opening tag according to FIG. 4;

FIG. 7 shows a perspective view, from above, of the face-plate according to FIG. 6 for receiving the opening tag;

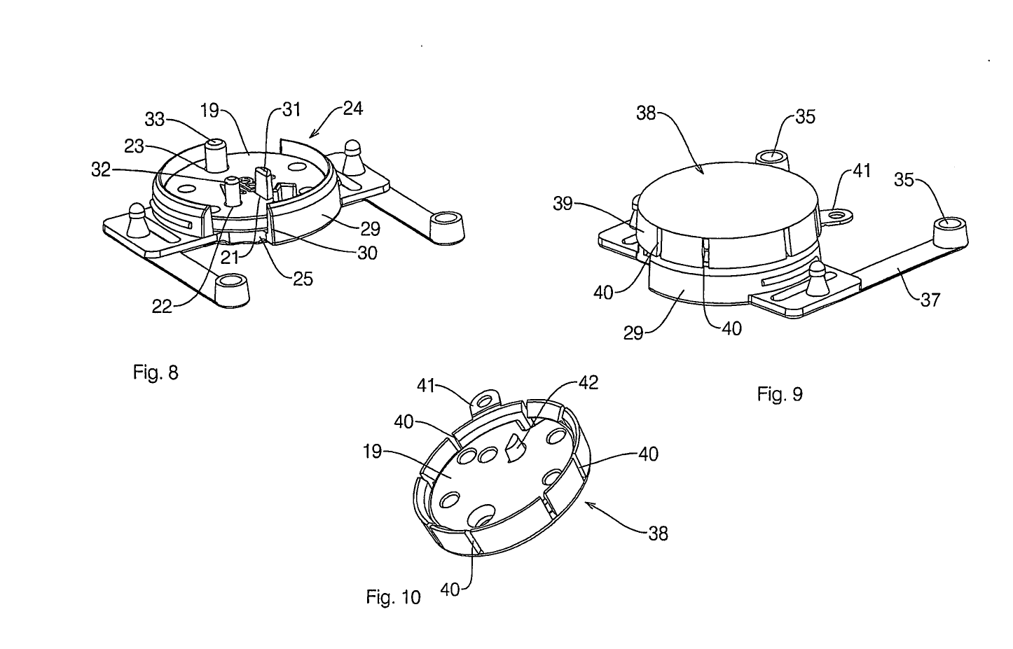

FIG. 8 shows a perspective view, from above, of the face-plate according to FIG. 6 with the opening tag placed thereon;

FIG. 9 shows a perspective view, from above, of the face-plate according to FIG. 8 with the tag placed thereon and with a tag closing and/or transportation cover;

FIG. 10 shows a perspective view, from below, of the opening tag positioned inside the cover according to FIG. 9;

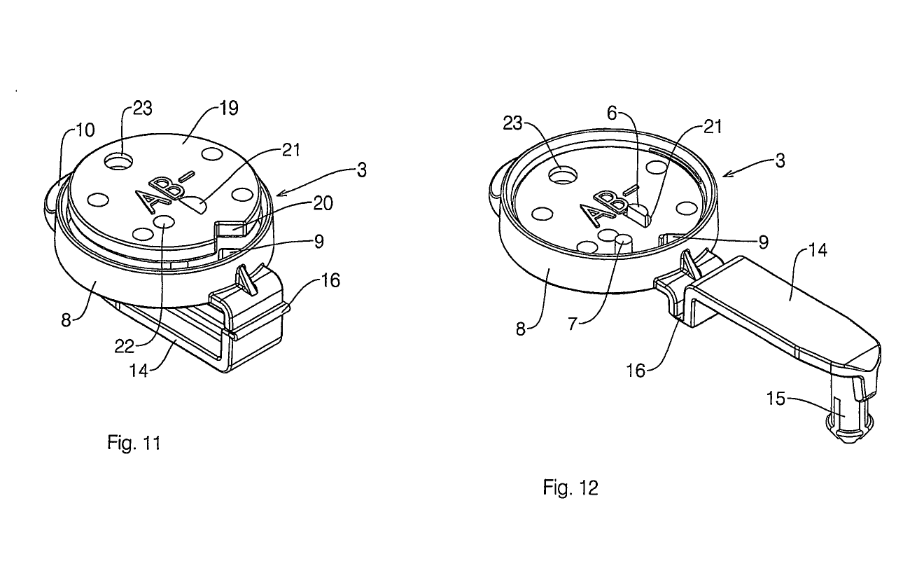

FIG. 11 shows a perspective view, from above, of the closed constriction device on which the associated opening tag is mounted;

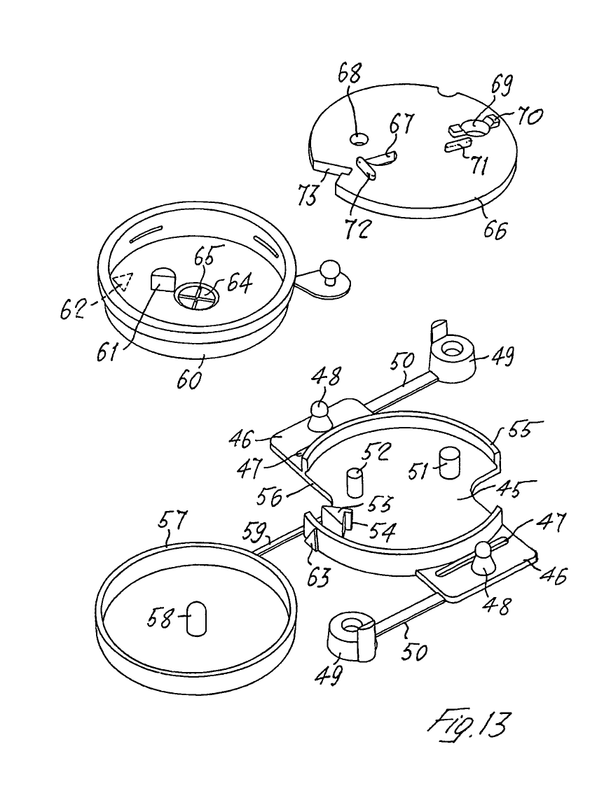

FIG. 12 shows a perspective view, from above, of the constriction device open with the associated opening tag inserted;

FIG. 13 shows a perspective view of a face-plate, a tag and a cover according to a second embodiment of the safety apparatus of the present invention;

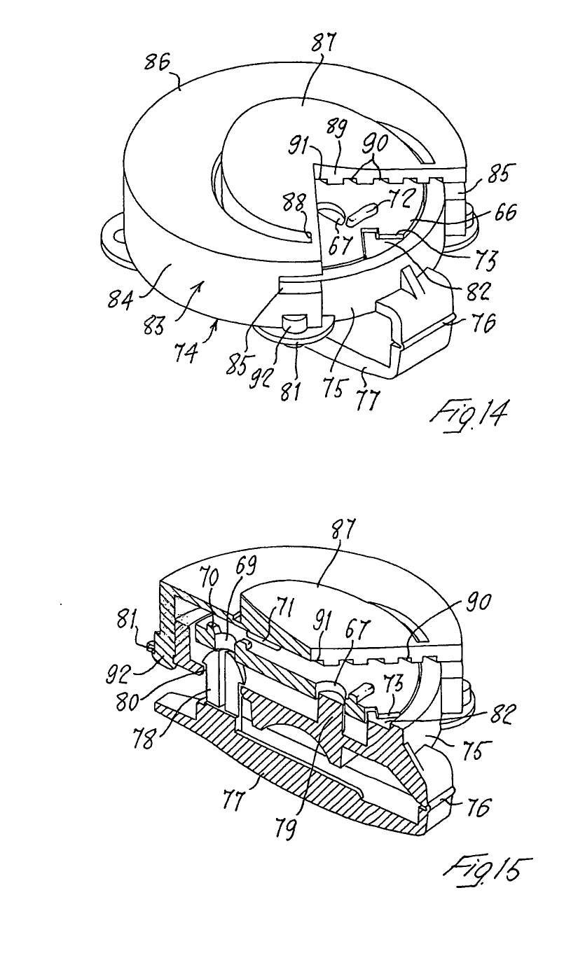

FIG. 14 shows a perspective view of a constriction device according to a second embodiment of the present invention;

FIG. 15 is a sectional perspective view of the device shown in FIG. 14;

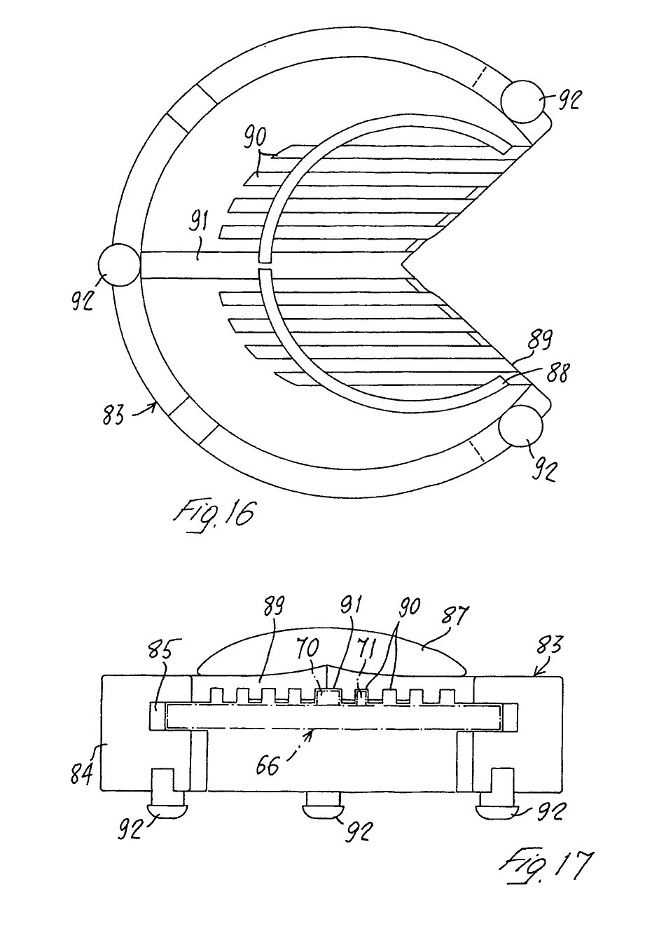

FIG. 16 is bottom plane view of an element of the device shown in FIG. 15; and

FIG. 17 is a front elevational view of the element shown in FIG. 16.

With reference to the accompanying drawings and with particular reference to FIG. 1 thereof, 1 denotes a bag containing blood or blood derivatives and bearing writing 43 indicating the blood group with Rh factor of said blood or blood derivatives, for example the group AB−. This bag 1 is provided at the bottom with at least one tube 2 for discharging the blood, made of elastically deformable material such as rubber or the like, to the bottom end of which suitable means, not shown, for connection to a venous catheter may be connected in a known manner. On said blood discharge tube 2 is mounted a constriction device 3 of the safety apparatus according to a first embodiment of the present invention, comprising a central disk 4, said disk being provided in a certain position with a through-hole 5 and having a raised annular edge 8 and bearing the said writing 43 indicating the blood group corresponding to that of the bag 1, hence AB-. Projecting teeth 6 and 7 are also arranged in a precise position on the front or facing surface of this central disk 4. These projecting teeth 6 and 7 represent essentially elements for coding and identifying the constriction device 3 relating to a given blood group. On the opposite side to that where said through-hole 5 is formed a projecting reference stud 9 is provided, adjacent to the raised annular edge 8. A projecting lug 10 is formed integrally on one side of said central disk 4 and has a hole 11 for receiving a tie 12 for irreversibly connecting the constriction device 3 to the bag 1 and to the cover 38. In this connection the bottom edge of said bag is provided with two holes 13 through one of which said irreversible connecting tie 12 passes. An arm-piece 14 is provided on the side of the central disk 4 opposite to that where said projecting lug 10 is provided, said arm-piece 14 being folded towards the rear of the central disk 4 and having at one end a ratchet pin 15 inserted inside the through-hole 5, for closing the constriction device 3 around the blood discharge tube 2.

This arm-piece 14 (see FIGS. 2 and 3 of the drawings) is formed as one piece with the central disk 4 and has in the vicinity of the annular edge 8 of said central disk 4 a weakened zone 16 about which it is able to rotate so that the ratchet pin 15 is inserted into the through-hole 5. As mentioned above, said arm-piece 14 is folded towards the rear part of the central disk 4, which has, formed thereon, a seat 17 with a shape corresponding to that of the tube 2 and provided internally with a series of transverse ribs 18. As can be understood, when the arm-piece 14 is folded towards said rear part of the central disk 4 and the ratchet pin 15 is inserted inside the associated through-hole 5, the blood discharge tube 2 is constricted between the inner side of said arm-piece 14 and the ribs 18 of said seat 17. Said constriction device 3 therefore prevents the blood from being removed from the bag 1 without—advantageously—interacting therewith.

In order to remove the constriction device 3 from the tube 2 and allow the blood to flow out from the bag 1, it is necessary to remove the ratchet pin 15 from the associated through-hole 5 of the central disk 4 and open the arm-piece 14. In order to remove this pin 15 it is necessary to use a suitable opening key co-operating with these coding elements 6, 7 present on the central disk 4 of the constriction device 3. In this connection FIGS. 4 and 5 show an opening tag 19 having a circular shape and provided with the writing 43 indicating the blood group AB− corresponding to that of the constriction device 3 and the bag 1. This tag 19 comprises on its outer edge an incision 20 having a shape complementing the projecting reference stud 9 of the central disk 4, and a series of identification through-holes: in particular the through-holes 21 and 22 precisely complement the projecting teeth 6 and 7 of said central disk 4. These through-holes 21 and 22, therefore, like the projecting teeth 6 and 7 of the disk, are situated in a precise position on the opening tag 19. This tag 19 also comprises a through-hole 23 with a substantially frustoconical shape so as to interact, as we shall see, with the ratchet pin 15 provided at the free end of the arm-piece 14.

FIG. 6 shows a wrist-band 24 for receiving and checking the opening tag 19. This wrist-band 24 comprises a face-plate 25 bearing the writing 43 indicating the blood group, i.e. in this example the group AB−, and provided on its two opposite sides with two lugs 26 projecting laterally and formed as one piece with said face-plate 25. Each of said projecting lugs 26 has, formed therein, a slit 27 through which a strap 28 for fastening the wrist-band 24 to the patient's wrist passes.

As can be seen from FIG. 7, this face-plate 25 comprises a raised annular edge 29 in which two openings 30 are formed, the function of which openings will be described below. The surface of the face-plate 25 has, formed in it, two projecting teeth 31 and 32 having a shape and position corresponding respectively to the through-holes 21 and 22 in said tag 19, a further cylindrical tooth 33, having a shape and a position corresponding to the through-hole 23 in the tag 19, and finally a projecting reference stud 34 adjacent to the raised annular edge 29 and having a shape and position corresponding to the incision 20 formed in the edge of the tag 19. 35 denotes two elements for permanently fixing in position the strap 28 with respect to the face-plate 25, which can be engaged with corresponding pins 36 projecting from the front surface of the lugs 26. This strap 28 is provided on both sides of the face-plate 25 with a series of through-holes 44, inside two of which said pins 36 will be inserted. Said permanent fixing elements 35 are spaced from said face-plate 25 and each connected by means of a flexible band 37 to said lugs 26. In FIG. 6 it is possible to see the flexible bands 37 folded onto themselves so that the elements 35 are engaged by means of pressure irreversibly with the associated pins 36.

FIG. 8 shows the opening tag 19 positioned on the face-plate 25 of the wrist-band 24 with the associated through-holes 21, 22 and 23 engaged respectively with the projecting teeth 31 and 32 and with the cylindrical pin 33. As can be seen, said pins 31 and 32 and said cylindrical pin 33 have a height which is greater than that of the tag 19, as does the raised annular edge 29 of the face-plate 25: this is envisaged so that it is possible to accommodate also several tags 19 of the same blood group, in this case AB−, on top of each other within the wrist-band 24. This face-plate 25 is also able to accommodate tags 19 for a blood group identical to that of the patient. If, for example, three tags 19 were stacked on top of each other inside the wrist-band 24, this would mean that the patient who must undergo a certain operation requires three bags 1 of blood each provided with an associated constriction device 3 which can be opened using one of the tags 19. The openings 30 formed in the raised annular edge 29 of the face-plate 25 have the function of facilitating the removal and allowing one to check the number of tags 19 which are positioned on the face-plate 25 of the wrist-band 24 fastened to the patient's wrist.

FIGS. 9 and 10 show a cover 38 for closing the face-plate 25. This cover 38 is provided with an annular edge 39 in which a series of substantially vertical divisions 40 are formed so as to facilitate extraction of the tag with pressure or with a rotary movement, and said annular edge 39 has, formed integrally on one side thereof, a projecting ring 41 by means of which said cover 38 can be mounted on the pins 36 or connected, for example by means of a folding band (not shown), with the holes in the bag and with the holes in the constriction device. Said cover 38 is provided internally with a projecting tooth 42 having a shape corresponding to the through-hole 21 formed in the opening tag 19 so as to ensure positioning thereof with the writing indicating the blood group directed downwards.

FIG. 11 shows the opening tag 19 which is about to be inserted inside the constriction device 3, with positioning of the incision 20 so that it engages with the projecting reference stud 9 adjacent to the raised annular edge 8 of said constriction device 3. By applying pressure to said tag 19 the frustoconical hole 23 will cause radial retraction of the ratchet pin 15, allowing the arm-piece 14 to be opened and extended as shown in FIG. 12. As can be seen, the through-holes 21 and 22 in the tag 19 are engaged respectively with the projecting teeth 6 and 7 and said tag remains inside the central disk 4 of the constriction device 3 in an irreversible manner as proof that it has been used.

In FIG. 13 is shown an alternative embodiment of the safety apparatus according to the present invention; namely, in the figure are illustrated a wrist face-plate 45, a tag 66 and a cover 60 similar to the devices shown in FIGS. 6 to 10. The face-plate 45 is provided on its two opposite sides with two lugs 46 projecting laterally and formed as one piece with the same face-plate 45. Each of said projecting lugs 46 has, formed therein, a slit 47 through which can pass the strap of the wrist-band, not shown in this figure. The said strap, which can be of the kind illustrated in FIG. 6, can be secured to the face-plate 45 by means of the fixing elements 49, which are spaced apart from the face-plate 45 and connected to the lugs 46 by means of the flexible bands 50. The fixing elements have to be inserted on the pins 48 projecting from the lugs 46, so as to secure the said strap.

The face-plate 45 comprises a raised annular edge 55 in which two openings 56 are formed; a flexible band 59 connects a cap 57 provided with an axial projecting stud 58 to the face-plate 45. From the surface of the face-plate 45 the teeth 51 and 52 are axially projecting, so as to be coupled with the corresponding through holes 69 and 68 of the tag 66. Accordingly, the reference stud 53, placed nearby the raised annular edge 55 and having the lateral relief 54, has a shape which corresponds to the shape of the incision 73 formed in the peripheral edge of the tag 66.

The tag 66 is also provided with a semi-circular through hole 67, and shows on one of its sides the projecting ribs 70, 71 and 72. The rib 70 is placed along the middle axis of the tag 66, and therefore is divided in two portions by the hole 69; the rib 71 is parallel to the said rib 70, and arranged at one side of the same. Finally, the rib 72 is perpendicular to the other two ribs, and positioned between the incision 73 and the semi-circular hole 67.

The cover 60 is provided, on the inner side of its closing plate, with a semi-circular tooth 61, which can be coupled with the corresponding hole 67 of the tag 66. Almost at the center of the closing plate of the said cover 60 is formed a diaphragm 64 having the fracture weakenings 65, whilst on the outer side of the said cover 60 is provided a reference element 62, for the correct positioning of the same cover 60; namely the reference element 62 have to arranged, when the cover is placed upon the face-plate 45, so as to match with the reference element 63 positioned on the outer surface of the annular edge 55.

In FIG. 14 is shown the constriction device 74 according to the second embodiment of the present invention; the said constriction device is provided with a lid 83 comprising a lateral wall 84 and an upper wall 86, the said lid being connected with the constriction device 74 by means of plugs 92 inserted into the slots formed in the radial lugs 81 projecting from the raised annular edge 75 of the said device. The lid 83 shows a wide opening 89 and, on both sides of the said opening 89, two slots 85 are provided for the introduction of the tag 66 into the constriction device 74; on the upper wall 86 of the said lid 83 is formed, integrally to the same lid, a pushbutton 87, which is separated from the upper wall 86, except for the limbs 88, near the opening 89. The inner face of the pushbutton 87 is provided with a plurality of lateral grooves 90 and with a central groove 91. Referring now tho FIG. 15, it is clear that the constriction device 74 has almost the same features of the constriction device 3 as previously described; in fact, an arm-piece 77 is provided, hinged by means of a weakened zone 76 to the said device. At the opposite end the arm-piece 14 has a ratchet pin 78, which is inserted inside the through hole 80. The hole 67 of the tag 66 cooperates with the tooth 79 axially projecting from the bottom of the constriction device 74, as well as the incision 73 cooperates with the reference stud 82.

The grooves 90, 91 are designed for the coupling with the ribs 71 and 70, respectively, formed on the surface of the tag 66; particularly, referring to FIGS. 16 and 17, the central groove 91 is formed so as to receive the rib 70 of the tag 66, i.e. having a guiding function, whilst the lateral grooves 90 will couple with the ribs of the kind of the rib 71, i.e. having an encoding function.

Obviously, the safety apparatus for transfusions according to both the embodiments of the present invention may comprise constriction devices with a different arrangement of the projecting coding teeth and/or other teeth having different functions, depending on the blood group to which they relate, so that it is possible to envisage as many constriction devices as there are blood groups available, with a greater or smaller number of projecting teeth, having a shape and number to be determined as required, provided that each of them involves a position of the projecting teeth and/or a number and/or a shape of the teeth different from those of another device. Thus, for example, there will be a constriction device for the blood group B+ having teeth arranged differently and/or different in terms of number and/or shape on the central disk, compared to those of the constriction device 3 illustrated for the group AB-. Consequently this constriction device for bags of blood B+ will have a corresponding opening tag to be arranged on the corresponding face-plate of an associated wrist-band.

We shall now consider a method for using the present safety apparatus for transfusions in the case of a patient who is required to undergo a given operation, according to the first embodiment of the present invention. In the transfusion centre the hospital personnel assigned this duty establishes, by means of cross-checked chemical analyses, the blood group contained inside the bag 1 and then writes this blood group and associated Rh factor, for example the blood group AB−, on said bag 1. The personnel will have at their disposal a series of constriction devices 3, each relating to a specific blood group with Rh factor. Then, after choosing the constriction device 3 with the writing AB−, the device is mounted on the blood outlet tube 2 of said bag 1, as described above, namely by folding the arm-piece 14 towards the rear of the central disk 4 and inserting the ratchet pin 15 inside the corresponding through-hole 5 formed in said central disk 4. This constriction device 3, by means of the tie 12, is connected in an irreversible manner to the bag 1; in this way any undesirable or incorrect access to the bag 1 containing the blood group AB− is prevented. This bag, once identified and provided with the constriction device 3, is placed inside a refrigerator in order to keep the blood in the required condition. In the hospital department where the patient waiting for the operation is situated, identification of the patient's blood group, for example the group AB−, is performed, and the data obtained is recorded in a hospital file and on a tab to be positioned on the strap 28 of the wrist-band 24 which will be fastened to the patient's wrist. Obviously in this case also the hospital personnel have at their disposal a series of face-plates 25 for each of the blood groups with associated Rh factor. Therefore after the face-plate 25 with the writing AB− has been selected, it is fixed in an irreversible manner by means of the permanent-fixing elements 35 to the strap 28 with the tab and then the wrist-band 24 obtained is fastened to the patient's wrist.

A cross-check is now carried out on the blood taken from the patient and that contained in the bag 1. This blood taken from the patient is sent to the transfusion centre and then a cross-check is performed with the blood contained inside the bag 1 by means of chemical analysis. The number of bags to be transfused, containing the same blood group AB−, is then selected, ready for sending to the hospital where the patient is located. Depending on the number of bags to be transfused, an equal number of tags 19 for opening the constriction device 3 provided for each bag 1 is then selected. The tags 19 together with the corresponding documentation relating to the checks carried out are delivered to the hospital department where the tags are inserted onto the face-plate 25 of the wrist-band 24, stacked on top of one another, as seen above. Since each tag 19 has a specific number, shape and arrangement of the through-holes 20, 21 and 22, it can be inserted only in the wrist-band 24 for the corresponding group. The bags 1 to be transfused are brought into the operating theatre of the hospital department and the tags 19 for opening the constriction devices 3—i.e. one tag 19 for each of the constriction devices 3—are removed from the patient's wrist-band 24. The constriction device 3 of each bag 1 is opened as described in the description of FIGS. 11 and 12 and remains fastened to said bag 1 by means of the connecting tie 12, by way of proof that the abovementioned procedures have been carried out.

Referring now to the second embodiment of the apparatus of the present invention, it is clearly apparent from the FIGS. 13 to 17 of the appended drawings that also this second embodiment follows almost the same operating procedures as above described. However, some particular procedural steps are advantageously improved, especially regarding the safety and the effectiveness of the whole operation.

The constriction device 74 as illustrated in FIGS. 14 and 15 is provided with a lid 83 which, in cooperation with the features of the tag 66, prevents in an almost definitive way the insertion of a wrong tag in a given constriction device. In fact, the constriction device 3 according to the first embodiment of the present invention allows, at least theoretically, the positioning of a tag 19 which may be not exactly corresponding to the code expressed in the said constriction device; the said tag may forced against the ratchet pin so as unlock it.

This problem is readily solved with the apparatus of this second embodiment of the invention; the tag 66 is in fact provided with ribs 71 which define, with their position on the surface of the said tag, the code for a given blood type. The lid is provided with a given number of grooves on the inner side of its upper wall, the said grooves thus allowing the insertion of tags 66 having the appropriated compatible features; in the embodiment shown in FIGS. 14 to 17, the lid shows the number of grooves corresponding to the universal donor blood type O+, that is to say that all the tags can be introduced in this specific constriction device.

The tag 66 is introduced in the constriction device 74 through the slots 85 formed on both sides of the opening 89. As it can be seen from FIGS. 16 and 17, the central rib 70 has only guiding functions, owing its cooperation with the central groove 91 of the lid 83, and all the tags 66 are therefore provided with such a rib. By this way it will result almost impossible to introduce the wrong tag in a given constriction device; moreover, the pushbutton 87 of the lid 83 from one side improves the opening operations of the said constriction device, which become now much more simple, and from the other side the same pushbutton 87 allows only to apply the pushing force substantially at the centre of the tag. By preventing the possibility of pushing the tag nearby the said ratchet pin, the constriction device 74 allows in fact only the opening operated by means of a tag having the coding means which are correctly matching with the coding means provided in the same constriction device.

The tag 66 shows also the asymmetrical incision 73, which allows the insertion of the said tag only in the correct way, that is to say only from one side, both in the face-plate 45 and in the constriction device 74. Furthermore, the cover 60 can be easily placed on the face-plate 45, and the removal of the tag(s) from the said cover can be rapidly achieved by putting the cap 57 on the said cover 60 and then pushing it so as to break the diaphragm 64 with the stud 58; the said stud will then extract the tag(s) out from the cover 60. The cover 60 has a diameter which less than that of the face-plate 45, so as to be easily arranged in the raised annular edge 55. Advantageously, the diaphragm 64 is provided with the fracture weakenings 65, which allow a much more easy penetration of the stud 58.

According to a further characteristic feature of the present invention, it also possible to envisage that all the persons concerned may be given an individual tag 19 or 66 to be carried on them at all times, coded in a manner corresponding to the blood type of the owner so that, in the event of being admitted to hospital in order to undergo a blood transfusion, the user may check whether the elements for coding and identifying his/her blood group and the associated Rh factor assigned to said said seat, namely the face-plate 25 or 45, actually correspond to those on their own tag.

1. Safety apparatus for transfusions of blood or blood derivatives contained inside at least one bag having at the bottom at least one tube made of elastically deformable material such as rubber or the like, for discharging the blood or blood derivatives, said blood or blood derivatives belonging to a given blood group with an associated Rh factor, characterized in that it comprises a constriction device closed by suitable clamping means movable about said tube so as to prevent the blood or blood derivatives which leave the bag from passing through said tube, said constriction device being provided with a seat on which suitable elements for coding and identifying said blood group with associated Rh factor are formed, which elements co-operate with a unique key for opening, in the event of compatibility, said constriction device provided with suitable elements complementing said coding elements and able to release said clamping means so as to open said constriction device and free said tube.

2. Apparatus according to claim 1, characterized in that said constriction device is connected in an irreversible manner and using suitable means to said bag, both in said position closed by said clamping means and in said open position with said clamping means unlocked.

3. Apparatus according to claim 1, characterized in that said opening key, used to check the identity of the patient's blood group and its compatibility to the receivable blood, is placed inside a seat formed in a wrist-band fixed to the wrist of a patient who is required to undergo a given operation.

4. Apparatus according to claim 1, characterized in that said bag, said constriction device, said opening key and said wrist-band bear the same writing identifying the blood group with associated Rh factor of the patient.

5. Apparatus according to claim 1, characterized in that opening keys indicating the blood group of the patient and the groups compatible with that of the patient are placed inside said seat of the wrist-band.

6. Apparatus according to claim 1, characterized in that said constriction device comprises a central disk having, arranged thereon in a precise position, projecting teeth co-operating with through-holes complementing said projecting teeth and formed in a similar position on a tag for opening said constriction device.

7. Apparatus according to claim 6, characterized in that said central disk comprises a raised annular edge.

8. Apparatus according to claim 7, characterized in that a projecting reference stud co-operating with an incision formed in the edge of said opening tag e is provided in the vicinity of the inner wall of said raised annular edge of the central disk.

9. Apparatus according to claim 8, in which the said reference stud and the cooperating incision have both a complementary asymmetrical profile.

10. Apparatus according to claim 6, characterized in that an arm-piece foldable towards the rear of said central disk by means of a suitable hinge is fixed or formed integrally on one side of said central disk, the free end of said arm-piece comprising a ratchet pin inserted inside a through-hole formed in said central disk for closing said constriction device and clamping said tube.

11. Apparatus according to claim 10, characterized in that said hinge is a weakened zone formed in the vicinity of the end of the arm-piece connected to said central disk.

12. Apparatus according to claim 10, characterized in that said opening tag comprises a substantially frustoconical through-hole for releasing by means of pressure said ratchet pin and for opening said constriction device

13. Apparatus according to claim 10, characterized in that said central disk has at the rear a seat inside which said tube is positioned and clamped between said arm-piece and said seat.

14. Apparatus according to claim 13, characterized in that said seat comprises a series of transverse ribs.

15. Apparatus according to claim 10, characterized in that the central disk is provided on the side opposite to that where said arm-piece is connected with a projecting lug having, formed thereon, a hole for fastening a tie for fixing in an irreversible manner said constriction device to said bag 1..

16. Apparatus according to claim 6, in which the said constriction device is further provided with a substantially cylindrical lid, firmly connected to the said constriction device, provided with an opening for the introduction of the said tag, the said opening being provided with means for coding the said introduction, said means for coding cooperating with complementary coding means provided on the said tag.

17. Apparatus according to claim 16, in which the said opening comprise a slot provided radially on the lateral wall of the said lid.

18. Apparatus according to claim 17, in which the said means for coding the introduction comprise one or more grooves formed at one edge of the said slot, the corresponding tag being provided with ribs compatible with the design of the said grooves.

19. Apparatus according to claim 16, in which the said lid comprise means for pushing the said tag against the said central disk.

20. Apparatus according to claim 3, characterized in that said wrist-band comprises a face-plate with, formed thereon, projecting teeth having a shape and position corresponding to the through-holes formed in said tag.

21. Apparatus according to claim 20, characterized in that said face-plate comprises a further cylindrical pin with which said substantially frustoconical hole formed in said opening tag can be engaged.

22. Apparatus according to claim 20, characterized in that said face-plate comprises a raised annular edge for receiving therein several opening tags of the same type stacked on top of one another, the number of said stacked tags corresponding to the number of bags with blood or blood derivatives of a same blood group, required by the patient.

23. Apparatus according to claim 22, characterized in that a projecting reference stud complementing said incision formed in the opening tag is provided on the inner wall of said annular edge of the face-plate.

24. Apparatus according to claim 23, in which the said reference stud and the complementing incision have both a complementary asymmetrical profile.

25. Apparatus according to claim 22, characterized in that the raised annular edge of said face-plate comprises one or more openings for facilitating extraction and for checking the number of tags stacked inside the wrist-band.

26. Apparatus according to claim 20, characterized in that said wrist-band comprises a strap for fastening to the patient's wrist, two lugs being formed on two opposite sides of the face-plate and being each provided with at least one slit through which said strap passes.

27. Apparatus according to claim 26, characterized in that each of said lugs is provided with a projecting pin and said strap is provided on both opposite sides of the face-plate with a series of through-holes, each projecting pin being inserted inside one of said through-holes of the strap and said projecting pin being engaged by suitable elements able to permanently fix the strap to the face-plate and connected by means of flexible bands e to said face-plate.

28. Apparatus according to claim 20, characterized in that said face-plate comprises a closing cover.

29. Apparatus according to claim 28, characterized in that said closing cover comprises an annular edge provided with a series of divisions or weakened zones suitable for facilitating extraction of the tag with a movement performed by means of pressure or rotation.

30. Apparatus according to claim 28, characterized in that said cover comprises internally a projecting tooth having a shape and position corresponding to one of the through-holes formed in the opening tag so as to ensure positioning with the writing indicating the blood group directed downwards.

31. Apparatus according to claim 28, characterized in that said cover comprises on its periphery one or more rings for connection to the body of said face-plate.

32. Apparatus according to claim 19, in which the said closing cover is provided with a diaphragm formed almost centrally in its closing plate, the said diaphragm being able to cooperate with an extraction member which can be inserted through the same diaphragm so as to extract the tag(s) from the said cover.

33. Apparatus according to claim 32, in which the said extraction member comprise a stud placed axially at the center of a cap, the said cap being couplable to the said cover, and being also firmly connected to the said face-plate.

34. Apparatus according to claim 32, in which the said diaphragm is provided with one or more fracture weakenings.

35. Apparatus according to claim 32, in which the said cover comprises internally a projecting tooth having a shape and position corresponding to one of the through-holes formed in the opening tag.

36. Method for using the safety apparatus for transfusions of blood or blood derivatives according to any one of the preceding claims, characterized by the following steps:
a) establishing the blood group with associated Rh factor contained inside a given bag;
b) recording on said bag information indicating said blood group with associated Rh factor;
c) mounting the constriction device with the same information on the tube for discharging the blood or blood derivatives from said bag;
d) connecting in an irreversible manner the chosen constriction device to said bag;
e) identifying the blood group with associated Rh factor of the patient and recording the data obtained in a hospital file and on a tab to be attached to the wrist-band fastened to the patient's wrist;
f) choosing the face-plate with information as to the blood group and associated Rh factor corresponding to that of the patient;
g) fixing the face-plate permanently to the strap;
h) fastening the wrist-band to the patient's wrist;
i) selecting the number of bags to be transfused, containing blood or blood derivatives with a blood group and associated Rh factor established beforehand and required by the patient;
j) choosing the number and type of tags corresponding to the blood group of the patient according to the number of bags required or associating with each individual bag a tag already inserted inside the cover;
k) placing the chosen tag or tags so that they are stacked on the face-plate of the wrist-band or releasing the tag from the cover by means of pressure or rotation;
l) removing, at the time of the operation to be carried out on the patient, the tag or tags present in the wrist-band and opening the corresponding constriction device or devices, i.e. one for each tag.

37. Method according to claim 36, characterized in that the abovementioned steps a), b), c), d), e), f), g), k) and l) are carried out in a transfusion center outside the hospital department where the patient is waiting to be operated on.

38. Method according to claim 36, characterized in that the steps d), e), h), k) and 1) are carried out in the department of the hospital where the patient is waiting to be operated on or where the transfusion is performed.

39. Method according to claim 36, characterized in that a further step involving checking and cross-checking of the patient's blood group and the blood group of the bags to be transfused is envisaged between the step g) and the step h).

40. Method according to claim 36, characterized in that said wrist-band is fastened to the patient upon admission to the hospital and, after step e), the face-plate with the information indicating the corresponding blood group and associated Rh factor is fixed thereto in an irreversible manner.

41. A method for using the safety apparatus according to claim 1, characterized by the following steps:
a) establishing the blood group with associated Rh factor contained inside a given bag;
b) recording on said bag information indicating said blood group with associated Rh factor;
c) mounting the constriction device with the same information on the tube for discharging the blood or blood derivatives from said bag;
d) connecting in an irreversible manner the chosen constriction device to said bag;
e) identifying the blood group with associated Rh factor of the patient and recording the data obtained in a hospital file and on a tab to be attached to the wrist-band fastened to the patient's wrist;
f) choosing the face-plate with information as to the blood group and associated Rh factor corresponding to that of the patient;
g) fixing the face-plate permanently to the strap;
h) fastening the wrist-band to the patient's wrist;
i) selecting the number of bags to be transfused, containing blood or blood derivatives with a blood group and associated Rh factor established beforehand and required by the patient;
i) choosing the number and type of tags corresponding to the blood group of the patient according to the number of bags required or associating with each individual bag a tag already inserted inside the cover;
k) placing the chosen tag or tags so that they are stacked on the face-plate of the wrist-band or releasing the tag from the cover by means of pressure or rotation;
l) removing, at the time of the operation to be carried out on the patient, the tag or tags present in the wrist-band and opening the corresponding constriction device or devices, i.e. one for each tag;
wherein it is possible to provide each person concerned with an individual tag, to be carried on them at all times, coded in a manner corresponding to the blood type of the owner so that, in the event of admission to hospital in order to undergo a blood transfusion, the user is able to check whether the elements coding and identifying his/her blood group and associated Rh factor assigned to said face-plate actually correspond to those on their own tag.
